(19) United States
(12) Patent Application Publication
(10) Pub. No.: US 2004/0180139 A1
(43) Pub. Date: Sep. 16, 2004

(54) Coated articles

(76) Inventors: James Riensche, Cedar Rapids, IA (US); Bryan Riensche, Cedar Rapids, IA (US)

Correspondence Address: James Riensche, 1530 Brett NW, Cedar Rapids, IA, 52405, US

(21) Appl. No.: 10/388,090

(22) Filed: Mar. 13, 2003

(51) Int. Cl. B05D 1/12

(52) U.S. Cl. 427/180; 427/314

(57) ABSTRACT

A process for coating low density composite articles made from wheat straw.

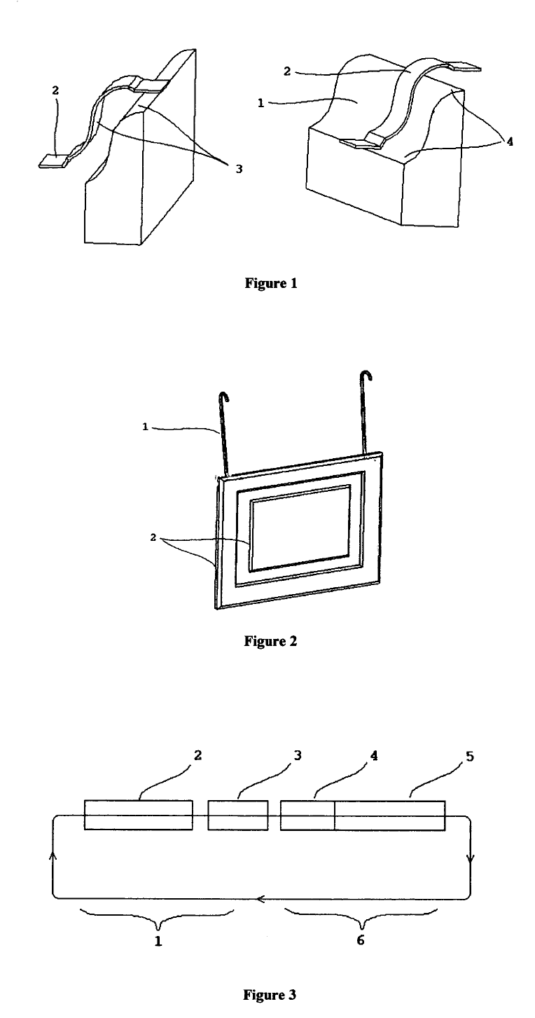

### FIELD OF THE INVENTION

This invention relates to improved methods of coating articles made from compressed wheat straw and other low density plant materials.

### BACKGROUND

Coated panels of wood based substrates are made in a variety of ways using various coatings as illustrated by the teachings of U.S. Pat. Nos. 5,851,607, 6,268,022, 6,433,099, and 6,509,413. Flannery U.S. Pat. No. 5,554,330 teaches the manufacture of the panels and substrates used in this invention. The panels of this invention are low density compared to more common higher density wood based panels. Coating the relatively low density panels relating to this invention presents problems not encountered in higher density wood based panels.

### SUMMARY

The invention relates to a process for coating vegetable particulate material articles. The process comprises the steps of preparing a smooth and particle free surface followed by grounding the article to metal. The surface of the article is heated with a ceramic gas fired infrared heater. All surfaces are coated simultaneously with pre-polymer using a corona discharge. The pre-polymer is heated to cause the pre-polymer to gel and finally the coated article is cured with heat.

### DETAILED DESCRIPTION

The process of this invention involves the steps of:

1. Machining the article to a final dimension;

2. Smoothing the surface of the article with sandpaper;

3. Cleaning the surface of the smoothed article to remove loose matter;

4. Heating the article in contact with a metal shoe machined to tightly fit the article and preferably in the temperature range of 380 degrees F. to 420 degrees F.;

5. Grounding electrically the article to a metal surface at a moisture content in the range of 5 to 10 percent;

6. Preheating the article with a gas fired ceramic infrared heater at a temperature preferably between 250 degrees F. to 400 degrees F. for a period between one to two minutes;

7. Coating both sides of the article simultaneously with particles of a low temperature curing catalyzed pre-polymer epoxy-polyester powder using a corona discharge in one uniform step to charge the particles;

8. Heating the article in an oven to gel the coating at between 170 degrees F. to 220 degrees F. for a period of 0.15 to 0.45 minutes;

9. Curing the article in a convection oven at a temperature between 300 to 400 degrees F. for a period of 1 to 3 minutes.

The equipment and supplies used in the practice of this invention are available from various sources. Pre-polymers are supplied by Protech of Quebec, Canada under the tradename Nuvocoat®. Corona discharge equipment is sold by ITW of Chicago, Ill. Ceramic gas fired infrared heaters are sold by Maxon of Muncice, Ind.

What is claimed is:

1. A process for coating vegetable particulate material articles comprising the steps of:
a. preparing a smooth and particle free surface;
b. grounding the article to metal;
c. heating the article in contact with a metal surface;
d. heating the surface with a ceramic gas fired infrared heater;
e. coating all surfaces simultaneously with pre-polymer using a corona discharge;
f. heating the pre-polymer to cause the pre-polymer to gel; and
g. curing the coated article with heat.

2. The process of claim 1 wherein the particulate matter is wheat straw.

3. The process of claim 1 wherein the particulate matter has a moisture content of 5 to 10 percent.

4. The process of claim 1 wherein the heated metallic surface is maintained at a temperature of 380 degrees F. to 420 degrees F.

5. The process of claim 1 wherein the article is uniformly and simultaneously coated on all surfaces with a catalyzed pre-polymer of a hybrid epoxy-polyester powder using a corona discharge.

6. The process of claim 1 wherein the article is heated in a shoe machined to tightly fit the article.

7. An article of manufacture of vegetable particulate material prepared by the process of claim 1.

8. The article of manufacture of claim 7 wherein the article is derived from wheat straw.
